(19) United States
(12) Patent Application Publication
(10) Pub. No.: US 2009/0037822 A1
(43) Pub. Date: Feb. 5, 2009

(54) CONTEXT-AWARE SHARED CONTENT REPRESENTATIONS

(75) Inventors: Kunal Kandekar, Raleigh, NC (US); Richard J. Walsh, Raleigh, NC (US); Christopher M. Amidon, Apex, NC (US)

Correspondence Address: FlashPoint Technology and Withrow & Terranova, 100 Regency Forest Drive, Suite 160, Cary, NC, 27518, US

(73) Assignee: QURIO HOLDINGS, INC., Raleigh, NC (US)

(21) Appl. No.: 11/831,196

(22) Filed: Jul. 31, 2007

(51) Int. Cl. G06F 3/01

(52) U.S. Cl. 715/733

(57) ABSTRACT

Systems and methods for providing context-aware content representations are disclosed. In general, the context-aware content representations are visual representations presented in association with a content representation host representative of a user or, alternatively, some other entity. The context-aware content representations are indicative of content made accessible by the user or of interest to the user and are additionally influenced by context. The context may be, for example, topics of social interactions such as text-based or voice-based conversations, device information descriptive of a device on which the accessible content is stored or through which the content is accessible, physical location, location within a virtual world, content access information related to content accessed by the user or entity represented by the content representation host or accessed by another user through the content representation host, or the like.

### FIELD OF THE INVENTION

The present invention relates to context-aware content representations.

### BACKGROUND OF THE INVENTION

There are many environments where users interact with each other and, as part of the interaction, share content. These environments include, for example, gaming, virtual worlds, online content sharing or social networking sites, and the like. One issue with these environments is that shared content is not portrayed in a way that is intuitive for content sharing. Users must often dive deep into content folders or user profiles only to discover that the content is of no interest. Thus, there is a need for a system and method for representing content shared or otherwise made available in such environments in a manner that enables users to intuitively identify other users having content of interest.

### SUMMARY OF THE INVENTION

The present invention relates to context-aware content representations. In general, the context-aware content representations are visual representations presented in association with a content representation host representative of a user or, alternatively, some other entity. The context-aware content representations are indicative of content made accessible by the user or of interest to the user and are additionally influenced by context. The context may be, for example, topics of social interactions such as text-based or voice-based conversations, device information descriptive of a device on which the accessible content is stored or through which the content is accessible, physical location, location within a virtual world, content access information related to content accessed by the user or entity represented by the content representation host or accessed by another user through the content representation host, or the like.

In one embodiment, the content representation host is an avatar representing the user within a virtual world. A context-aware content representation is generated and presented in association with the avatar of the user within the virtual world. As a result of the context-aware content representation, other users participating in the virtual world can quickly and easily determine one or more types of content made accessible by the user or of interest to the user represented by the avatar. In various alternative embodiments, the content representation host may be an avatar of the user, some other representation of the user, or an identifier of the user on a webpage, in a contact list, or the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIGS. 1 and 2 illustrate context-aware content representations according to one embodiment of the present invention;

FIG. 3 illustrates a system for implementing context-aware content representations in a virtual environment according to one embodiment of the present invention;

FIG. 4 illustrates a context-aware content representation (CR) engine according to one embodiment of the present invention;

FIG. 5 illustrates the operation of the contextual input processing function of FIG. 4 according to one embodiment of the present invention;

FIG. 6 illustrates the operation of the context-aware CR engine of FIG. 4 according to one embodiment of the present invention;

FIG. 7 is a block diagram of a client device hosting the context-aware CR engine of FIG. 4 according to one embodiment of the present invention;

FIG. 8 is a functional block diagram of one of the virtual environment (VE) servers of FIG. 3 wherein the context-aware CR engine of FIG. 4 is implemented on the VE server according to one embodiment of the present invention;

FIG. 9 is a block diagram of the VE server of FIG. 8 according to one embodiment of the present invention; and

FIGS. 10-17 illustrate various exemplary context-aware content representations according to various embodiments of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to context-aware content representations. In general, the context-aware content representations are visual representations presented in association with a content representation host representative of a user or, alternatively, some other entity. The context-aware content representations are indicative of content made accessible by the user or of interest to the user and are additionally indicative of context. The context may be, for example, topics of social interactions such as text-based or voice-based conversations, device information descriptive of a device on which the accessible content is stored or through which the content is accessible, physical location, location within a virtual world, content access information related to content accessed by the user or entity represented by the content representation host or accessed by another user through the content representation host, or the like.

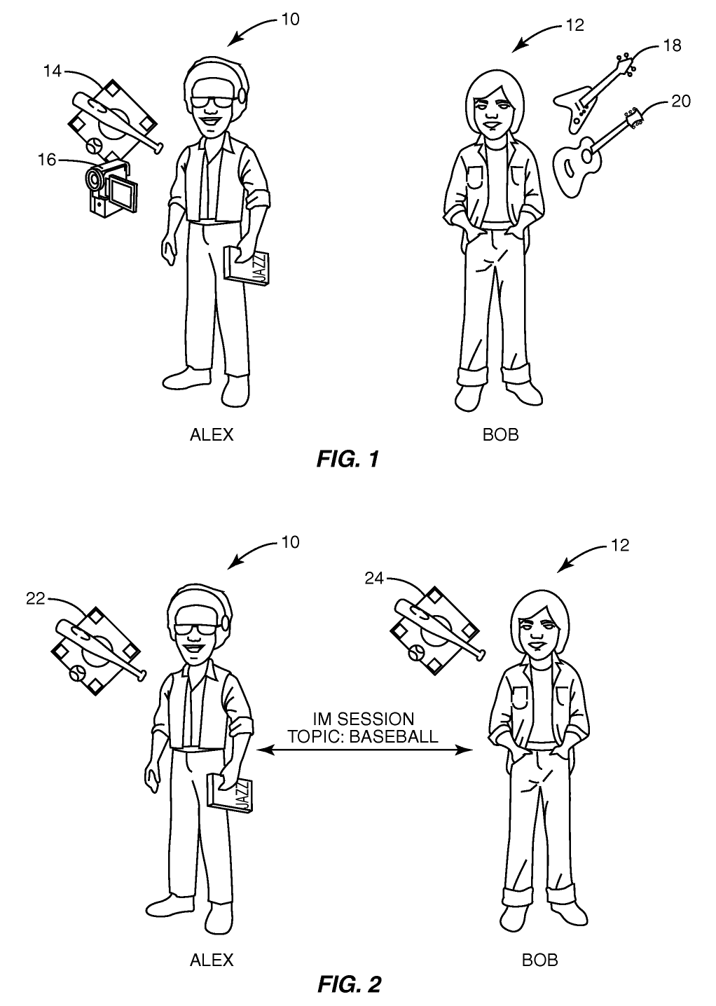

In one embodiment, the content representation host is an avatar representing the user within a virtual world. Note that while much of the discussion herein focuses on avatars in a virtual world as the exemplary content representation host, the present invention is not limited thereto. FIGS. 1 and 2 illustrate avatars 10 and 12 representing users “Alex” and “Bob” according to one embodiment of the present invention. In FIG. 1, content representations 14 and 16 are presented in association with the avatar 10. The content representation 14 visually indicates that Alex is sharing or otherwise making accessible content related to the topic of baseball. The content representation 16 visually indicates that Alex is sharing or otherwise making accessible video content. Together, the content representations 14 and 16 indicate that Alex is sharing or otherwise making accessible video content related to the topic of baseball. Content representations 18 and 20 are presented in association with the avatar 12 of Bob. The content representation 18 visually indicates that Bob is sharing or otherwise making accessible content from the Rock music genre. The content representation 20 visually indicates that Bob is sharing or otherwise making accessible content from the Country music genre. Note that FIG. 1 illustrates the general concept of content representations as disclosed in U.S. patent application Ser. No. 11/678,781, entitled SYSTEM AND METHOD FOR REPRESENTING CONTENT; U.S. patent application Ser. No. 11/678,798, entitled LAYERED VISUALIZATION OF CONTENT REPRESENTATIONS; and U.S. patent application Ser. No. 11/678,813, entitled INTERACTIVE CONTENT REPRESENTATIONS ENABLING CONTENT SHARING, all of which were filed on Feb. 26, 2007 and are hereby incorporated herein by reference in their entireties. In an alternative embodiment, the content representations may be presented in association with a group of avatars in a manner similar to that disclosed in U.S. patent application Ser. No. 11/760,019, entitled GROUP CONTENT REPRESENTATIONS, which was filed on Jun. 8, 2007 and is hereby incorporated herein by reference in its entirety.

FIG. 2 illustrates the same avatars 10 and 12, wherein context-aware content representations 22 and 24 are presented in association with the avatars 10 and 12, respectively, according to one embodiment of the present invention. More specifically, the users Alex and Bob are interacting via an Instant Messaging (IM) session or conversation related to a topic “baseball.” As such, a context-aware content representation (CR) engine, which is discussed below, operates to render the context-aware content representation 22 in association with the avatar 10 of Alex. The context-aware content representation 22 is indicative of both the content made accessible by Alex as well as the IM session between Alex and Bob related to the topic of baseball. In one embodiment, the content representations 14 and 16 of FIG. 1 are filtered based on the topic of the IM session to provide the context-aware content representation 22. However, the present invention is not limited thereto. In this example, since Bob is not sharing or otherwise making accessible content related to baseball, both of the content representations 18 and 20 are filtered based on the topic of the IM session. As such, the context-aware CR engine may presume that Bob has an interest in baseball from the fact that he is engaging in a conversation about baseball with Alex and operate to render the context-aware content representation 24 to visually indicate that, based on context, Bob is interested in baseball. Note that the context-aware content representation 24 may be modified or highlighted in a manner that indicates that Bob has an interest in baseball but is not sharing baseball content.

It should be noted that FIGS. 1 and 2 are exemplary and intended only to provide a general understanding of one embodiment of the present invention. Numerous variations are discussed herein and further variations will be apparent to one of ordinary skill in the art upon reading this disclosure.

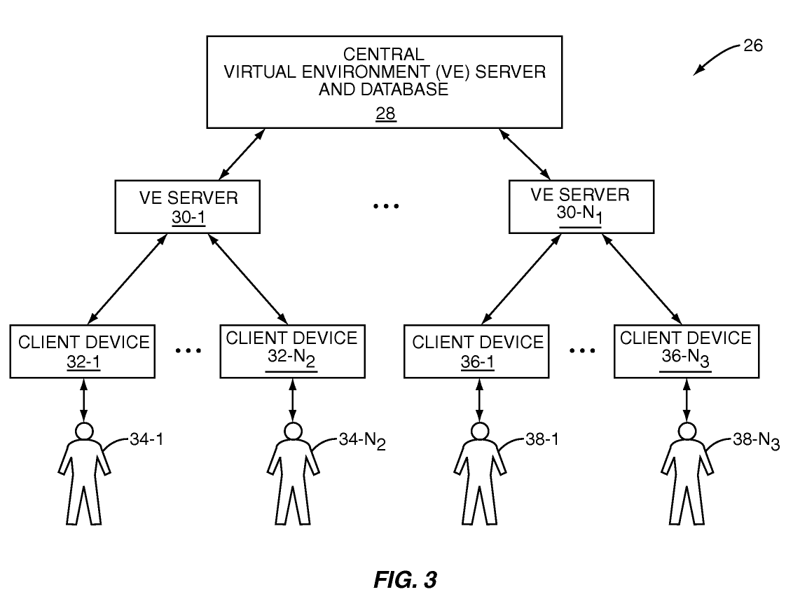

FIG. 3 illustrates an exemplary embodiment of a system 26 providing a virtual environment in which context-aware content representations are implemented according to one embodiment of the present invention. It should be noted that the system 26 of FIG. 3 is exemplary and not intended to limit the scope of the present invention. The virtual environment may be a virtual world such as, for example, Second Life, a virtual gaming environment such as a Massively Multiplayer Online Role Playing Game (MMORPG), or the like.

In general, the system 26 includes a central virtual environment (VE) server and database 28 and a number of distributed VE servers 30-1 through 30-N₁. The VE server 30-1 serves a number of client devices 32-1 through 32-N₂ having associated users 34-1 through 34-N₂. Likewise, the VE server 30-N₁ serves a number of client devices 36-1 through 36-N₃ having associated users 38-1 through 38-N₃. The central VE server and database 28 manages user accounts and may also manage overall game logic and the like. The VE servers 30-1 through 30-N₁ manage interactions and user events and provide a client specific view of the virtual environment to the client devices 32-1 through 32-N₂ and 36-1 through 36-N₃. The client devices 32-1 through 32-N₂ and 36-1 through 36-N₃ may be, for example, personal computers, mobile devices such as mobile telephones or Personal Digital Assistants (PDAs), game consoles, or the like and generally include either a custom software application or a web browser enabling interaction with the VE servers 30-1 through 30-N₁ for participation in the virtual environment.

Note that in an alternative embodiment, the operation of the central VE server and database 28 and optionally the VE servers 30-1 through 30-N₁ may be distributed among the other devices in the system 26. For example, the operation of the central VE server and database 28 may be distributed among the VE servers 30-1 through 30-N₁. As another example, the operation of the central VE server and database 28 and the VE servers 30-1 through 30-N₁ may be distributed among the client devices 32-1 through 32-N₂ and 36-1 through 36-N₃. As a final example, the functionality of the VE servers 30-1 through 30-N₁ may be implemented on the central VE server and database 28.

According to one embodiment of the present invention, the users 34-1 through 34-N₂ and 38-1 through 38-N₃ are represented by avatars in the virtual environment. An avatar is a representation of a user in the form of a three-dimensional model, a two-dimensional icon, or the like. As discussed below in more detail, in order to enable, for example, the user 34-1 to locate others of the users 34-2 through 34-N₂ and 38-1 through 38-N₃ sharing or otherwise making accessible content of interest to the user 34-1, the system 26 effects presentation of context-aware content representations in association with the avatars of the users 34-1 through 34-N₂ and 38-1 through 38-N₃. The avatars are more generally referred to herein as content representation hosts. In addition or alternatively, context-aware content representations may be associated with other virtual objects in the virtual environment such as, for example, storefronts in the virtual environment, a virtual stereo of a user in the virtual environment, or the like, where the virtual objects may provide access to shared or otherwise available content.

The context-aware content representations are descriptive of content shared or otherwise made accessible by the users 34-1 through 34-N₂ and 38-1 through 38-N₃ from the client devices 32-1 through 32-N₂ and 36-1 through 36-N₃ and/or content of interest to the users 34-1 through 34-N₂ and 38-1 through 38-N₃. The content made accessible by the users 34-1 through 34-N₂ and 38-1 through 38-N₃ may be audio content such as songs or music; video content such as movies, television programs, or video clips; pictures; games; or the like. While this disclosure focuses on the aforementioned types of content, the present invention is not limited thereto. The content may additionally or alternatively be any other type of digital content such as, for example, user profiles, activities or interaction events in the virtual environment, hobbies, web pages, or the like.

Note that the content made accessible by the users 34-1 through 34-N₂ and 38-1 through 38-N₃ is generally hosted by the client devices 32-1 through 32-N₂ and 36-1 through 36-N₃. However, the content may alternatively be hosted by, for example, the central VE server and database 28, one or more of the VE servers 30-1 through 30-N₁, a third party server such as a server providing a centrally hosted content sharing service, a Peer-to-Peer (P2P) content sharing service, or the like, or any combination thereof.

The context-aware content representations may be indicative of, for example, content type such as music, video, picture, or the like; genre such as music genre, movie genre, or television program genre; artist such as music artist, actor, or actress; time period of release; acoustic styles; keywords; or the like. In addition, the context-aware content representations may be indicative of content quality, quantity of content, availability or accessibility, copyright or Digital Rights Management (DRM) restriction, or the like or any combination thereof. In addition, the context-aware content representations take into account contextual information such as, for example, topics of social interactions such as text-based or voice-based conversations, device information descriptive of a device on which the accessible content is stored or through which the content is accessible, physical location, location within a virtual world, content access information related to content accessed by the user or entity represented by the content representation host or accessed by another user through the content representation host, or the like.

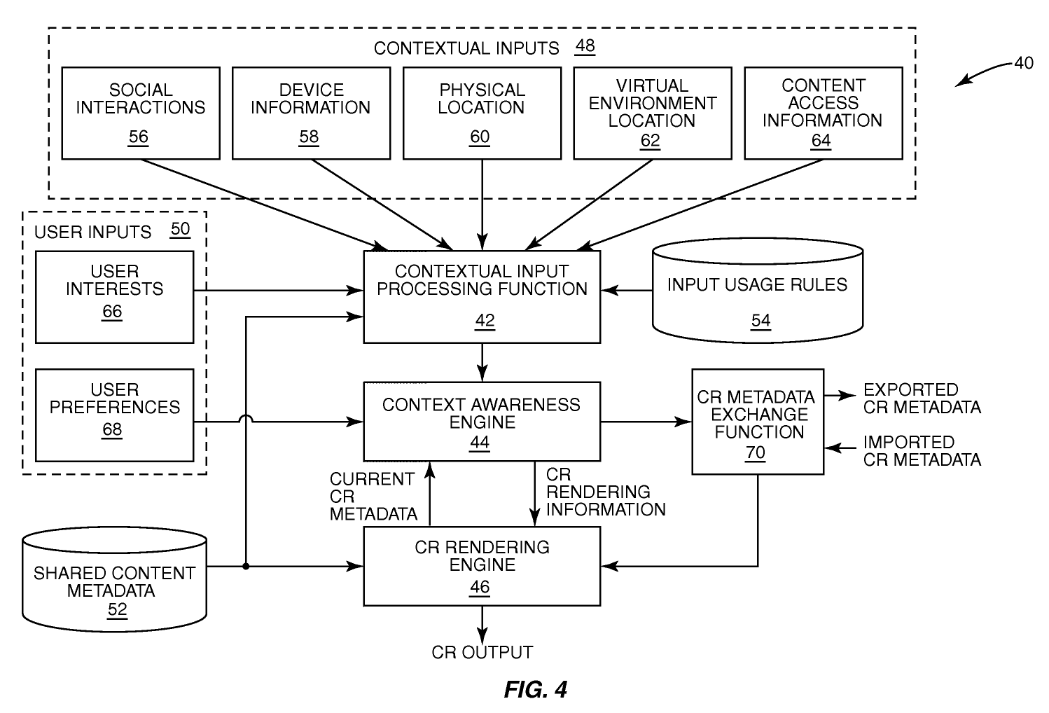

FIG. 4 illustrates a context-aware content representation (CR) engine 40 according to one embodiment of the present invention. In general, the context-aware CR engine 40 operates to provide the context-aware representations to render in association with one or more content representation hosts. In one embodiment, a separate context-aware CR engine 40 is implemented on each of the client devices 32-1 through 32-N₂ and 36-1 through 36-N₃. As an example, the context-aware CR engine 40 may be implemented on the client device 32-1 and operate to render the context-aware content representation in association with the avatar of the user 34-1 within the virtual world.

While the following discussion focuses on this embodiment where the context-aware CR engine 40 is implemented on one of the client devices 32-1 through 32-N₂ and 36-1 through 36-N₃, the present invention is not limited thereto. In an alternative embodiment, a separate context-aware CR engine 40 may be implemented on each of the VE servers 30-1 through 30-N₁. As an example, the context-aware CR engine 40 may be implemented on the VE server 30-1 and operate to render context-aware content representations in association with the avatars of the users 34-1 through 34-N₂. As another alternative, the context-aware CR engine 40 may be implemented on one or more remote devices. For example, if the client device 32-1 is a light-weight portable device having minimal processing capabilities, the context-aware CR engine 40 may be implemented on, for example, a personal computer of the user 34-1, wherein the personal computer of the user 34-1 effects rendering of the context-aware content representation in association with the avatar of the user 34-1 on behalf of the client device 32-1.

In this example, the context-aware CR engine 40 is implemented on the client device 32-1. The context-aware CR engine 40 generally includes a contextual input processing function 42, a context awareness engine 44, and a CR rendering engine 46, which each may be implemented in software, hardware, or a combination of software and hardware. Note that while illustrated separately, any two or more of the contextual input processing function 42, the context awareness engine 44, and the CR rendering engine 46 may be combined into a single function. The contextual input processing function 42, the context awareness engine 44, and the CR rendering engine 46 operate based on a number of contextual inputs 48, a number of user inputs 50, shared content metadata 52, and input usage rules 54. The contextual inputs 48 may include, for example, a social interaction input 56, a device information input 58, a physical location input 60, a virtual environment location input 62, and a content access information input 64.

The social interaction input 56 is from one or more social interaction applications such as a text-based or voice-based chat application hosted by the client device 32-1 or some associated device of the user 34-1. The social interaction input 56 may be, for example, the text of a text-based chat session, the voice data of a voice-based chat session, keywords extracted from a text-based or voice-based chat session, or the like. The device information input 58 may be obtained from the client device 32-1 hosting the context-aware CR engine 40 and/or any other devices hosting content made accessible via the user 34-1. The device information input 58 may include information such as device type, device capabilities, or the like.

The physical location input 60 may be from, for example, an associated Global Positioning System (GPS) receiver, a device equipped with a GPS receiver, or the like and includes information defining the location of the user 34-1. The information defining the location of the user 34-1 may be, for example, latitude and longitude coordinates defining the physical location of the user 34-1, a street address of the location of the user 34-1, the name of a nearby city or landmark, or the like. Note that the physical location of the user 34-1 may be used for context by, for example, modifying or highlighting a Jazz content representation if the user 34-1 is in Memphis, modifying or highlighting a Baseball content representation is the user 34-1 is near a ballpark, or the like. In an alternative embodiment, if the content made accessible by the user 34-1 is stored on one or more remote devices, the physical location input 60 may provide the location of the remote devices on which the content is stored, which may be referred to herein as the location of the content.

The virtual environment location input 62 includes information defining a location of the avatar of the user 34-1 within the virtual world. The information defining the location of the avatar within the virtual world may include coordinates within the virtual world, a name or address of the location of the avatar within the virtual world, a description of the location of the avatar in the virtual world, or the like. The virtual environment location input 62 may be obtained from a VE client function hosted by the client device 32-1 or from the VE server 30-1. In addition, the virtual environment location input 62 may include information from or regarding the users of nearby avatars in the virtual world. This information may include all or a portion of the shared content metadata of those users, information identifying or describing the content representations currently being presented in association with the nearby avatars, interests or preferences of those users, or the like.

The content access information input 64 may include information identifying content currently being accessed from the client device 32-1 and information identifying the one or more users that are accessing the content. In addition or alternatively, the content access information input 64 may provide information identifying content currently being accessed by the user 34-1 from one or more of the other client devices 32-2 through 32-N₂ and 36-1 through 36-N₃. The content access information input 64 may be obtained from any application enabling the user 34-1 to share and/or access content. For example, a VE client function may be hosted by the client device 32-1 to enable the user 34-1 to interact with the virtual environment. The VE client function may also enable the user 34-1 to share content and access content made accessible by one or more of the other users 34-2 through 34-N₂ and 38-1 through 38-N₃. As such, the content access information input 64 may be obtained from the VE client function. In a similar fashion, the content access information input 64 may be obtained from any other application that enables the user 34-1 to share content or access content made accessible from the other users 34-2 through 34-N₂ and 36-1 through 36-N₃. In addition, the content access information input 64 may be obtained from any application that enables the user 34-1 to access local content or content from some other remote source. The content access information input 64 may also include information regarding the content made accessible by the user 34-1 such as DRM restrictions and the like, which may be obtained from, for example, the shared content metadata 52.

In this example, the user inputs 50 include user interests 66 and user preferences 68. The user interests 66 include, for example, one or more keywords or other metadata describing content of interest or disinterest to the user 34-1. For example, the user interests 66 may include one or more content types, one or more music or video genres, one or more artists or actors, one or more time periods, or the like. The user preferences 68 may identify one or more of the contextual inputs 48 to emphasize, identify one or more of the contextual inputs 48 to ignore, assign priorities to the contextual inputs 48, or the like.

The shared content metadata 52 includes metadata for information describing the content made accessible by the user 34-1. Again, the content made accessible by the user 34-1 may be stored by the client device 32-1, one or more devices of the user 34-1 associated with the client device 32-1, by a P2P or centrally hosted content sharing service, or the like, or any combination thereof. The content made accessible by the user 34-1 generally includes a number of content items. As used herein, a content item may be any type of digital content item such as, for example, a song, a movie, a television program, a video clip, a picture, or the like. The content metadata for each content item may vary depending on the type of content item. For example, for each song, the content metadata may include the title of the song, the album on which the song was released, the artist of the song, the release date of the song, the genre or classification of the song, information defining the quality of the song such as the encoding parameters used to encode the song, and DRM or copyright restrictions. In addition, the content metadata may include availability or accessibility information such as information reflecting a connection speed of the associated client device hosting the song, estimated download time, a reference or Uniform Resource Locator (URL) providing access to the associated content, or the like. The input usage rules 54 generally include rules or other information enabling the contextual input processing function 42 to process the contextual inputs 48.

In one embodiment, the contextual input processing function 42 may be implemented as a number of plug-ins. Thus, if the social interaction input 56 includes input from a text-based or voice-based chat application, the contextual input processing function 42 may include a plug-in that obtains the social interaction input 56 from the chat application. Note that, if any of the contextual inputs 48 are provided from devices of the user 34-1 other than the client device 32-1, the associated plug-ins may be implemented on the other devices from which the contextual input are to be obtained. For example, if the social interaction input 56 includes voice data or keywords extracted from voice data from a telephone conversation of the user 34-1 on an associated mobile telephone, a plug-in may be implemented on the mobile telephone and operate to provide the voice data or keywords extracted from the voice data to the context awareness engine 44 at the client device 32-1. Note that contextual inputs obtained from the client device 32-1 or from an application hosted by the client device 32-1 are referred to herein as being received from a local source. In contrast, contextual inputs obtained from remote devices are referred to herein as being obtained from remote sources.

In operation, the contextual input processing function 42 obtains the contextual inputs 48 from corresponding sources and outputs relevant context information to the context awareness engine 44. More specifically, in one embodiment, the contextual input processing function 42 obtains the contextual inputs 48 from the corresponding sources. The contextual input processing function 42 then processes the contextual inputs 48 based on the shared content metadata 52, the user interests 66 of the user 34-1, and the input usage rules 54 to identify one or more keywords or other metadata from the contextual inputs 48 that are relevant to the content made accessible by the user 34-1 and/or the user interests 66 of the user 34-1. The relevant keywords or other relevant metadata are then provided to the context-awareness engine 44.

Based on the information from the contextual input processing function 42 and the user preferences 68, the context awareness engine 44 effects rendering of context-aware content representations in association with the avatar of the user 34-1 within the virtual environment. More specifically, in one embodiment, the context awareness engine 44 obtains current CR metadata from the CR rendering engine 46. The current CR metadata describes or identifies a number of content representations applicable to the content made accessible by the user 34-1. In one embodiment, the applicable content representations are identified by the CR rendering engine 46 based on the shared content metadata 52 in the manner described in U.S. patent application Ser. No. 11/678,781. Alternatively, the context awareness engine 44 may generate the list of applicable content representations based on the shared content metadata 52.

The context awareness engine 44 processes the list of applicable content representations based on the information from the contextual input processing function 42 to provide CR rendering information identifying one or more context-aware content representations to be rendered in association with the avatar of the user 34-1. More specifically, in one embodiment, the context awareness engine 44 filters the applicable content representations based on the relevant keywords or metadata identified in the contextual inputs 48. In addition or alternatively, the context awareness engine 44 may add content representations to the list of applicable content representations based on the user interests 66 of the user 34-1 and/or based on the relevant keywords or other metadata from the contextual input processing function 42. Thus, even if the user 34-1 is not sharing content meeting the criteria for a particular content representation, the content representation may be added to the list of applicable content representations if the user 34-1 has expressed an interest or disinterest in content satisfying the criteria for the content representation or if the contextual inputs indicate that the user 34-1 has an interest in content satisfying the criteria for the content representation. The context awareness engine 44 may also modify or highlight, or provide instructions to modify or highlight, select ones of the applicable content representations. For example, if the user 34-1 is not sharing Rock content but has expressed an interest in Rock content either directly via the user interests 66 or indirectly by participating in a chat session about a topic related to Rock content, the context awareness engine 44 may add the Rock content representation to the list of applicable content representations and provide instructions to either modify or highlight the Rock content representation to indicate that the user 34-1 has only an interest in Rock content. Note that the Rock content representation may itself be modified to include some indication that the user 34-1 has only an interest in Rock content. Alternatively, the Rock content representation may be highlighted by, for example, overlaying some visual indicator onto the Rock content representation, adjusting a brightness of the Rock content representation, or the like.

In this embodiment, the CR rendering engine 46 first generates a list of applicable content representations based on the shared content metadata 52. More specifically, in one embodiment, the CR rendering engine 46 includes information defining a number of content representations that may be used by the context-aware CR engine 40. The content representations may be system defined, user defined, or any combination thereof. A number of rules or other criteria are provided for each of the content representations, where the rules or other criteria are to be used to determine when the content representations are applicable. The CR rendering engine 46 compares the shared content metadata 52 to the rules or other criteria for the content representations to identify the content representations that are applicable to the content shared by the user 34-1. For example, a Rock content representation may have an associated rule stating that the Rock content representation, such as content representation 18 of FIG. 1, is applicable to music content from the Rock genre. As such, if the shared content metadata 52 includes metadata for one or more songs from the Rock genre, the Rock content representation is applicable to the content shared by the user 34-1. Note that the content representations and associated rules may be defined by an ontology, taxonomy, or similar data structure.

Once the applicable content representations are identified, the current CR metadata, which may be a list of the applicable content representations, is provided to the context awareness engine 44 for processing. The context awareness engine 44 processes the current CR metadata to provide the CR rendering information in the manner described above. Again, the CR rendering information may include a list of context-aware content representations and any modification and/or highlighting instructions. Upon receiving the CR rendering information from the context awareness engine 44, the CR rendering engine 46 provides a CR output in order to render the context-aware content representations in association with the avatar of the user 34-1 within the virtual world. When rendering the context-aware content representations, the CR rendering engine 46 may perform any modifications and/or highlighting as instructed by the context awareness engine 44. If the number of context-aware content representations is greater than some desired threshold, the CR rendering engine 46 may select one or more of the context-aware content representations to be rendered based on, for example, a defined preference of the user 34-1.

In one embodiment, the context-aware content representations may be arranged into a data structure such as a tree. For example, if the context-aware content representations include a Music content representation, a Rock content representation, and a number of Rock artist content representations, the context-aware content representations may be combined to form a content representation tree where the Music content representation is the first level of the tree, the Rock content representation is the second level of the tree, and the Rock artist content representations are the third level of the tree. The CR rendering engine 46 may automatically render one of the levels of the tree such as the first level. Alternatively, the user 34-1 may define a preference as to which level of the tree is initially rendered. As another alternative, the CR rendering engine 46 may select which level of the tree to initially render based on any desired criteria. Thereafter, a viewer, such as the user 34-2, may interact with the context-aware content representation rendered in association with the avatar of the user 34-1 within the virtual world in order to navigate up or down the content representation tree. Alternatively, the CR rendering engine 46 may automatically navigate up or down the content representation tree based on a distance between the avatar of the user 34-1 and the avatar of a viewer such as the user 34-2 within the virtual world.

The context-aware CR engine 40 may also include a CR metadata exchange function 70. The CR metadata exchange function 70 may be implemented in software, hardware, or a combination thereof. In general, the CR metadata exchange function 70 operates to exchange content representations or metadata for content representations with other context-aware CR engines 40. For example, looking at FIG. 2, if Bob is not sharing baseball content, his client device may not have the baseball content representation. As such, the CR metadata exchange function of Alex's client device may provide the baseball content representation and all associated rules and criteria to the client device of Bob such that Bob's context-aware CR engine 40 is enabled to display the baseball content representation in association with Bob's avatar.

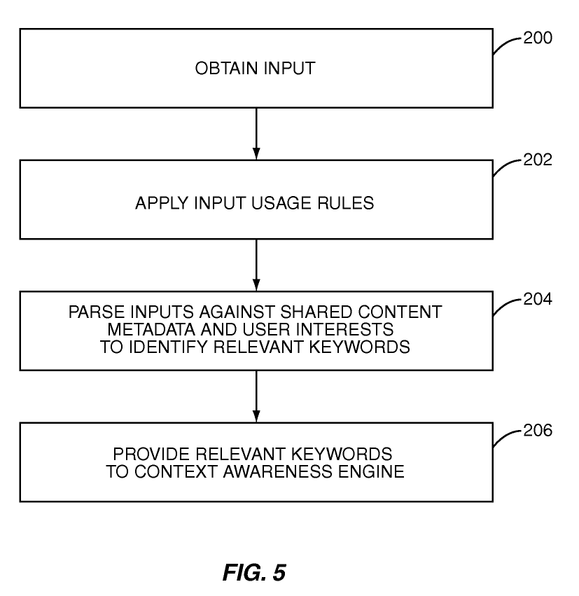

FIG. 5 is a flow chart illustrating the operation of the contextual input processing function 42 according to one embodiment of the present invention. As discussed above, the contextual input processing function 42 first accepts one or more of the contextual inputs 48 (step 200). Note that if the contextual input processing function 42 is implemented as a number of separate plug-ins, each of the plug-ins may perform the process of FIG. 5. Upon receiving the contextual input 48, the contextual input processing function 42 applies one or more input usage rules 54 for the contextual input 48 (step 202). In general, the input usage rules 54 define how the contextual input 48 is to be accepted and used. More specifically, in one embodiment, the contextual input 48 is in a text-based or Extensible Markup Language (XML) format, and the input usage rules 54 define how the contextual input 48 is to be parsed, which fields are to be parsed, or the like. Also note that the input usage rules 54 may alternatively be application code or functions for parsing the input. As an example, the input usage rules 54 for the contextual input 48 may state that the contextual input 48 is to be parsed and the resultant text is to be compared with the shared content metadata 52 and the user interests 66 to provide relevant keywords. As another example, the input usage rules 54 for the physical location input 60 may include a number of rules for converting GPS coordinates into a text-based location prior to parsing. The text-based location may be, for example, the city and state in which the user is located, a street address at which the user is located, a name of a nearby landmark, or the like.

Next, the contextual input processing function 42 parses the contextual input 48 according to the input usage rules 54, which in this case instructs the contextual input processing function 42 to parse the contextual input 48 against the shared content metadata 52 and the user interests 66 to identify relevant keywords (step 204). Note that an ontology, taxonomy, or similar data structure may be used to provide semantic relationships between words or phrases. For example, if the contextual input includes the words “Steven Tyler,” the contextual input processing function 42 may identify a match with the Rock band Aerosmith. Lastly, the contextual input processing function 42 provides the relevant keywords to the context awareness engine 44 (step 206). In one embodiment, the relevant keywords are provided to the context awareness engine 44 in a standard format such that the relevant keywords for each of the contextual inputs 48 are provided to the context awareness engine 44 in the same format.

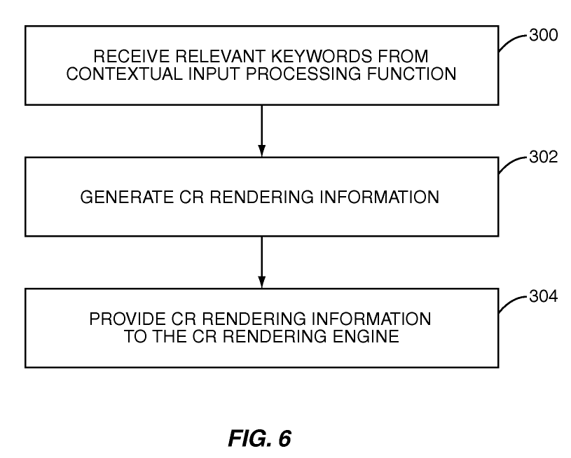

FIG. 6 is a flow chart illustrating the operation of the context awareness engine 44 according to one embodiment of the present invention. First, the context awareness engine 44 receives the relevant keywords from the contextual input processing function 42 for one or more of the contextual inputs 48 (step 300). Next, the context awareness engine 44 generates the CR rendering information (step 302). As discussed above, in one embodiment, the CR rendering engine 46 provides information identifying a number of applicable content representations to the context awareness engine 44. Alternatively, the context awareness engine 44 may identify the applicable content representations based on the shared content metadata 52. The context awareness engine 44 then processes the list of applicable content representations based on the relevant keywords from the contextual inputs 48 to provide the context-aware content representations to be rendered in association with the avatar of the user 34-1 within the virtual world. The context awareness engine 44 may filter the applicable content representations to remove content representations that are not related to the relevant keywords from the contextual inputs 48. The context awareness engine 44 may additionally or alternatively add content representations to the list of applicable content representations based on interests of the user 34-1 expressed in the user interests 66 or inferred from the relevant keywords from the contextual inputs 48. Still further, the context awareness engine 44 may provide instructions to modify or highlight the applicable content representations. For example, the context awareness engine 44 may provide instructions to modify or highlight a particular content representation to include appropriate visual information if the user 34-1 has only an interest or disinterest in the associated content and is not sharing associated content. As another example, the context awareness engine 44 may provide instructions to modify or highlight a particular content representation to include appropriate visual information if the corresponding content is DRM protected. While the discussion herein focuses on modifying or highlighting the applicable content representations, the context awareness engine 44 may delete or remove a content representation from the applicable content representations when appropriate.

Once the CR rendering information is generated, the context awareness engine 44 provides the CR rendering information to the CR rendering engine 46 (step 304). As discussed above, the CR rendering engine 46 modifies or highlights context-aware content representations as instructed and renders one or more of the context-aware content representations in association with the avatar of the user 34-1 within the virtual world.

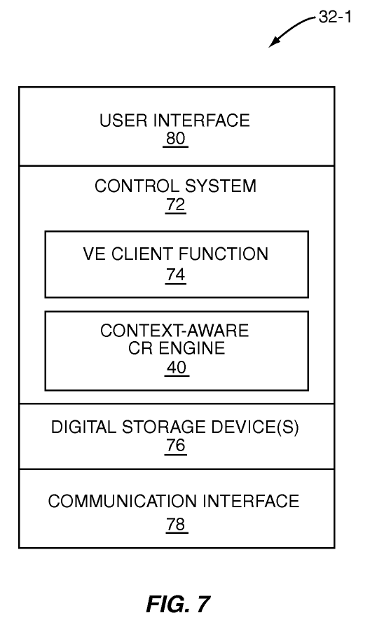

FIG. 7 is a block diagram of the client device 32-1 according to one embodiment of the present invention. In general, the client device 32-1 includes a control system 72 including a VE client function 74 and the context-aware CR engine 40. The VE client function 74 enables the user 34-1 to interact with the virtual environment. The context-aware CR engine 40 may interact with the VE client function 74 to render the context-aware content representations in association with the avatar of the user 34-1. As an alternative, the context-aware CR engine 40 may be implemented as part of the VE client function 74. The client device 32-1 may also include one or more digital storage devices 76 for storing content shared or otherwise made accessible by the user 34-1. The digital storage devices 76 may be, for example, hard disk drives, memory, or the like. The client device 32-1 also includes a communication interface 78 for communicating with the VE server 30-1 via a network such as, for example, the Internet. The network may be wired, wireless, or a combination thereof. The client device 32-1 also includes a user interface 80, which may include components such as a display, one or more user input devices, speakers, and the like.

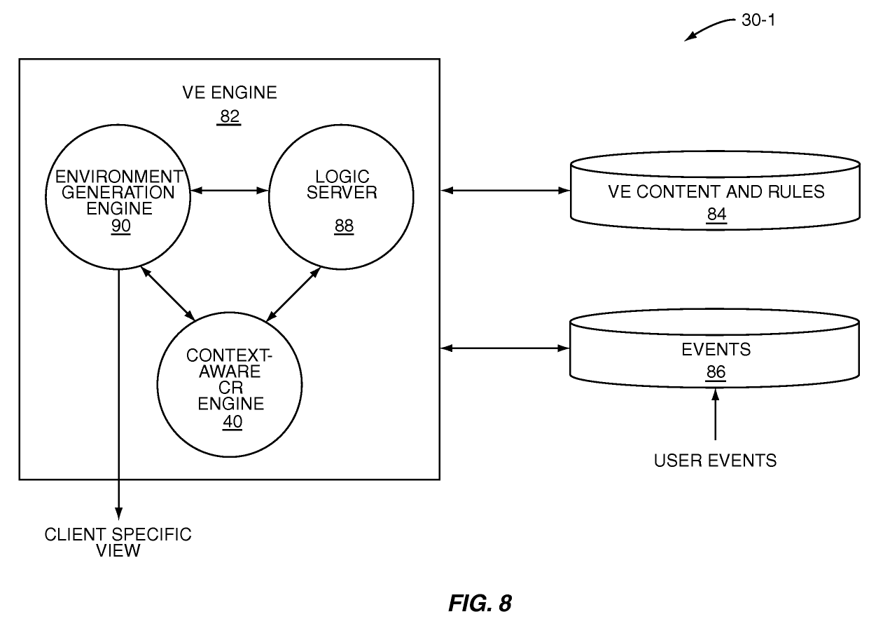

FIG. 8 is a functional block diagram of an alternative embodiment of the present invention wherein the context-aware CR engine 40 is implemented on the VE server 30-1. In this case, context-aware CR engines 40 would also be implemented on the other VE servers 30-2 through 30-N₁. As illustrated, the VE server 30-1 includes a VE engine 82, a VE content and rules database 84, and an events database 86.

The events database 86 stores incoming user events from the client devices 32-1 through 32-N₂ and 36-1 through 36-N₃. The user events may be any user event permitted in the virtual environment. For example, the user event may be related to movement of the user's avatar within the virtual environment or entry of the avatar into the virtual environment.

The VE engine 82 may be implemented in software, hardware, or a combination thereof. In general, VE engine 82 operates to provide a client specific view of the virtual environment to each of the client devices 32-1 through 32-N₂ based on user events received from the client devices 32-1 through 32-N₂. The VE engine 82 includes a logic server 88, an environment generation engine 90, and the context-aware CR engine 40. Using the VE content and rules database 84, the logic server 88 and the environment generation engine 90 operate to process user events from the client devices 32-1 through 32-N₂ and provide client specific views of the virtual environment to the client devices 32-1 through 32-N₂. In a manner similar to that discussed above, the context-aware CR engine 40 receives contextual inputs 48 and user inputs 50 for each of the users 34-1 through 34-N₂. Based on the contextual inputs 48 and user inputs 50, the context-aware CR engine 40 provides context-aware content representations for the avatars of the users 34-1 through 34-N₂ and effects presentation of the context-aware content representations in association with the avatars in the virtual environment. The context-aware CR engine 40 interacts with the logic server 88 and the environment generation engine 90 to effect presentation of content representations within the virtual environment according to one embodiment of the present invention.

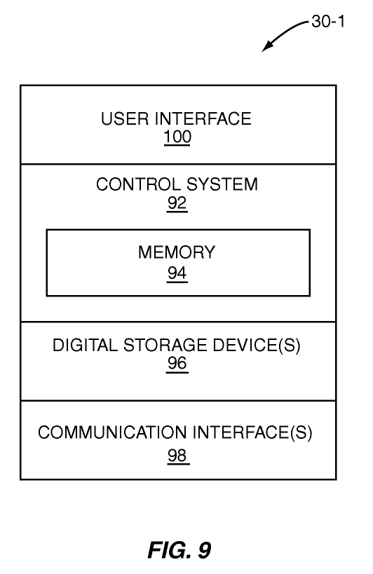

FIG. 9 is a block diagram of an exemplary implementation of the VE server 30-1 of FIG. 8. In general, the VE server 30-1 includes a control system 92 having associated memory 94. In this example, the context-aware CR engine 40, the logic server 88, and the environment generation engine 90 are each implemented in software and are stored in the memory 94. However, the present invention is not limited thereto. Each of the context-aware CR engine 40, the logic server 88, and the environment generation engine 90 may be implemented in software, hardware, or a combination thereof. The VE server 30-1 may also include one or more digital storage devices 96 such as, for example, one or more hard disk drives, memory, or the like. The databases 84 and 86 may, for example, be stored in the digital storage devices 96. The VE server 30-1 also includes one or more communication interfaces 98 communicatively coupling the VE server 30-1 to the client devices 32-1 through 32-N₂ and the central VE server and database 28 via one or more networks. The one or more networks may be wired, wireless, or a combination thereof. The VE server 30-1 may also include a user interface 100, which may include, for example, a display, one or more user input devices, and the like.

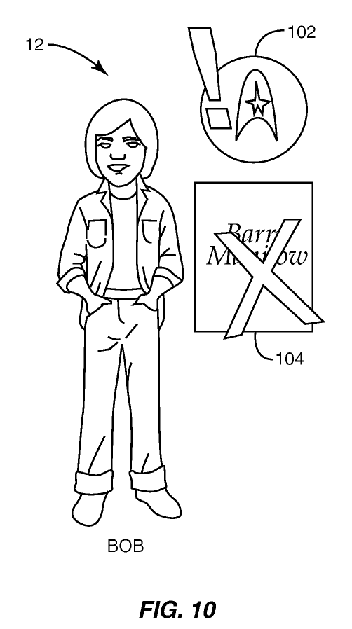

FIGS. 10-15 illustrate a number of context-aware content representations provided according to exemplary embodiments of the present invention. However, note that the present invention is not limited thereto. Numerous variations will be apparent to one of ordinary skill in the art upon reading this disclosure. More specifically, FIG. 10 illustrates two context-aware content representations 102 and 104 rendered in association with Bob's avatar 12. The context-aware content representation 102 is a Star Trek content representation that has been modified or highlighted by an exclamation point to indicate that Bob has expressed an interest in Star Trek content either directly via his user interests or indirectly by, for example, participating in a conversation or chat session about Star Trek or some related topic. Using metadata describing content made accessible by nearby users and/or interests of nearby users in the virtual environment as a contextual input, the context-aware content representation 102 may be presented if one or more users sharing or interested in Star Trek content are near the avatar 12 within the virtual environment.

In contrast, the context-aware content representation 104 is a Barry Manilow content representation that has been modified or highlighted by an “X” to indicate that Bob has expressed a disinterest in Barry Manilow content. Again, metadata describing content made accessible by nearby users and/or interests of nearby users in the virtual environment may be used as a contextual input. As such, the context-aware content representation 104 may be presented if one or more users sharing Barry Manilow content are near the avatar 12 within the virtual environment or if one or more users having an interest or disinterest in Barry Manilow content are near the avatar 12 within the virtual environment.

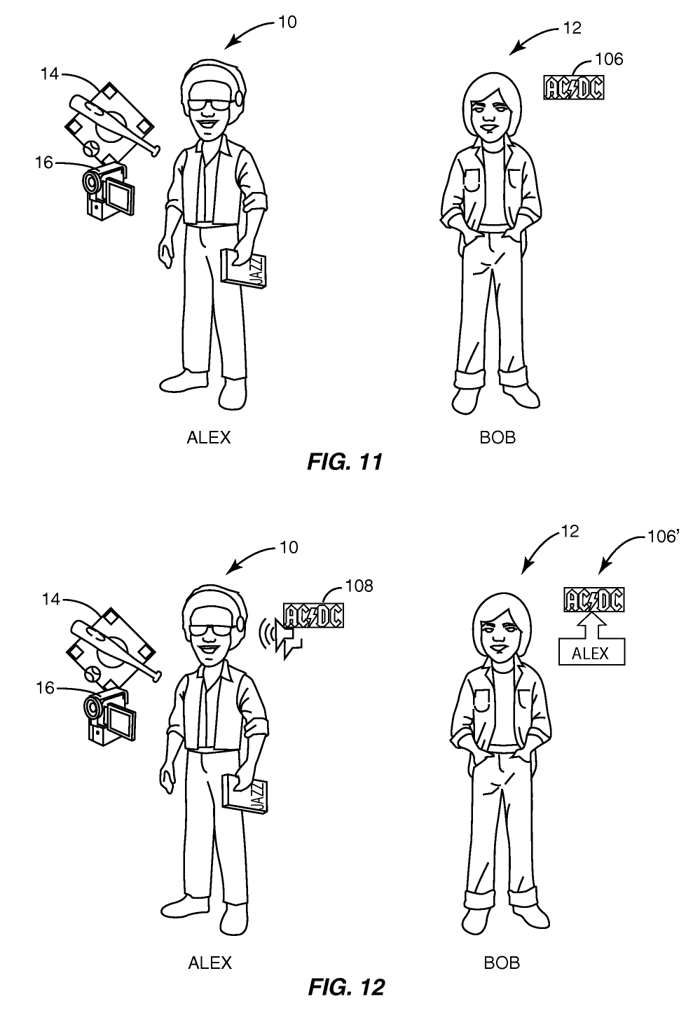

FIGS. 11 and 12 illustrate a scenario where the context-aware content representations are modified or highlighted to include information about content access. More specifically, FIG. 11 illustrates the avatars 10 and 12 of Alex and Bob. The avatar 10 of Alex is the same as illustrated in FIG. 1. An AC/DC content representation 106 is presented in association with Bob's avatar 12. Note that the AC/DC content representation 106 may be rendered in response to Alex's interactions with the Rock content representation 18 (FIG. 1). FIG. 12 illustrates the same two avatars 10 and 12 after Alex has chosen to access the AC/DC content shared or otherwise made accessible by Bob. As such, a context-aware content representation 108 is rendered in association with Alex's avatar 10 in order to indicate that Alex is currently accessing AC/DC content. The context-aware content representation 108 may be provided by modifying or highlighting a pre-existing AC/DC content representation with the illustrated speaker. Note that the context-aware CR engine 40 associated with Alex may obtain the AC/DC content representation from the context-aware CR engine 40 associated with Bob via the CR metadata exchange functions 70 of the two context-aware CR engines 40. In a similar fashion, the AC/DC content representation 106 may be modified or highlighted to include Alex's name or alternatively some other identifier of Alex to provide a context-aware content representation 106′ that indicates that Alex is currently accessing the corresponding content.

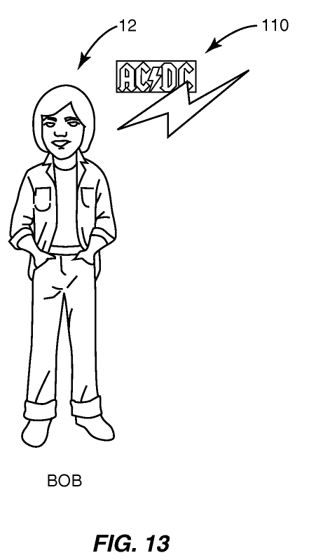

FIG. 13 illustrates a scenario where a content representation is modified or highlighted to provide a context-aware content representation based on the user's current activity, physical location, or virtual world location. For example, if Bob is at a live AC/DC concert or if Bob's avatar 12 is in a Rock bar in the virtual world in which Rock content or AC/DC content is being played, the context-aware CR engine 40 may modify or highlight an AC/DC content representation with some corresponding indicator to provide a context-aware content representation 110 for presentation in association with Bob's avatar. The fact that Bob is at a live AC/DC concert may be inferred from, for example, GPS location and a known event schedule for the concert venue, from a calendar or schedule maintained by Bob, or the like.

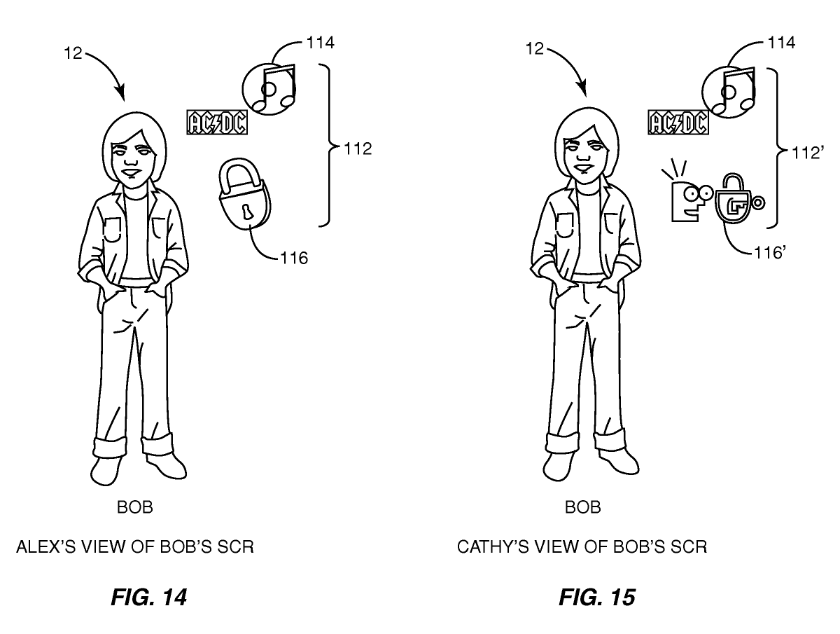

FIGS. 14 and 15 illustrate a scenario where a content representation is modified or highlighted to include visual indications of content properties such as the source of the content and any DRM restrictions or watermarks. Further, FIGS. 14 and 15 illustrate that context-aware content representations may also vary depending on the viewer. FIG. 14 illustrates a context-aware content representation 112 in association with Bob's avatar as viewed by a first viewer, which in this case is Alex. The context-aware content representation 112 is an AC/DC content representation that has been modified or highlighted to include visual indicators of the properties of the AC/DC content shared or otherwise made accessible by Bob. More specifically, the context-aware content representation 112 includes a visual indicator 114 of a source of the content, which in this case is Apple's iTunes® music store. The context-aware content representation 112 also includes a visual indicator 116 that indicates that the content is DRM protected. Note that Alex may be enabled to interact with the context-aware content representation 112 and more specifically the visual indicator 116 to acquire rights to the shared content, to view instructions on how to acquire rights to the shared content, to acquire the content from the content source, or the like.

FIG. 15 illustrates the context-aware content representation 112′ from the view of a second user, which in this case is Cathy. The context-aware content representation 112′ is essentially the same. However, in this case, Cathy, unlike Alex above, has rights to access Bob's AC/DC content. As such, the context-aware content representation 112′ is modified or highlighted to include a visual indicator 116′ rather than the visual indicator 116 (FIG. 14) to indicate that the content is DRM protected and that Cathy has rights to access the content. Also, while not illustrated in FIGS. 14 and 15, the context-aware content representations 112 and 112′ may also be modified or highlighted to provide visual indications of other content properties such as availability. For example, if the device on which the content is hosted is currently unavailable, the context-aware content representations 112 and 112′ may be displayed in black and white rather than in color.

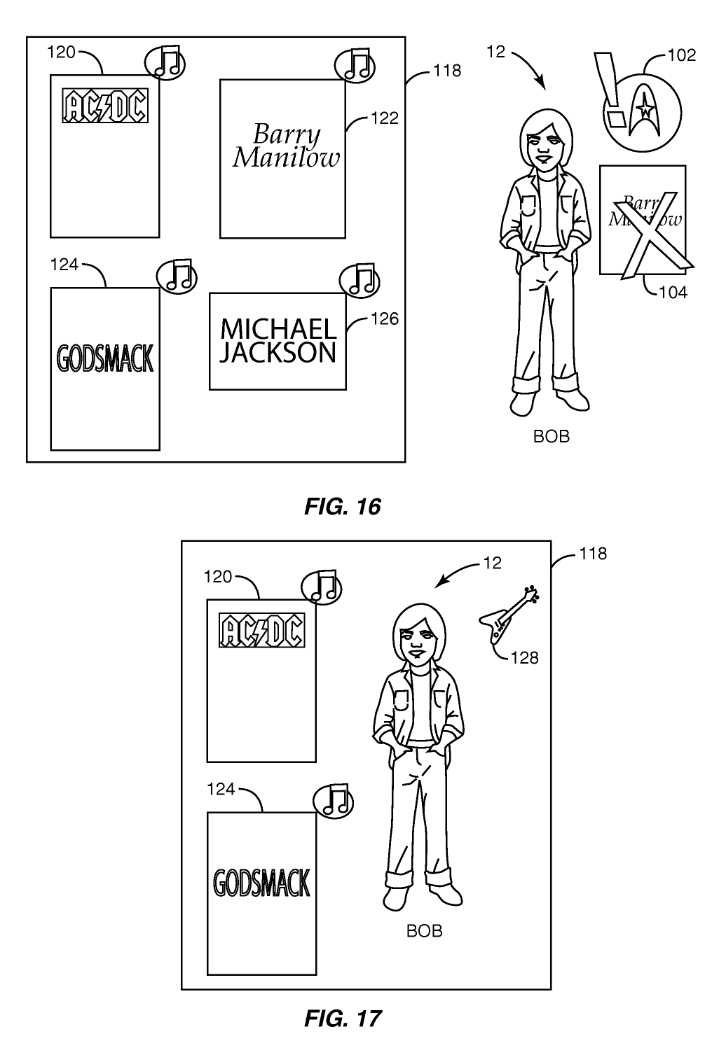

FIGS. 16 and 17 illustrate another scenario where VE location is used as a contextual input. More specifically, FIG. 16 illustrates a virtual music store 118 similar to that which may be found in a virtual environment such as a virtual world. A number of content representations 120-126 are presented within the virtual music store 118 as visual indicators of content accessible from the virtual music store 118. FIG. 16 also illustrates the avatar 12 of the user Bob. In this example, the context-aware content representations 102 and 104 are rendered in association with the avatar 12 to show Bob's interest in Star Trek content and disinterest in Barry Manilow content.

FIG. 17 illustrates the virtual music store 118 and the avatar 12 after the avatar 12 has entered the virtual music store 118. More specifically, the interests and disinterests of Bob and optionally additional information such as all or a portion of Bob's shared content metadata 52 are provided to the virtual music store 118 as a contextual input. In response, the context-aware CR engine 40 associated with the virtual music store 118 filters the content representations 120-126 based on contextual inputs for Bob such that only the content representations 120 and 124 are presented. After filtering, the content representations 120 and 124 are referred to herein as context-aware content representations. In a similar fashion, one or more contextual inputs such as, for example, the VE location of Bob's avatar 12, which is within the virtual music store 118, or metadata describing the content made accessible by the virtual music store 118 are processed by the context-aware CR engine 40 associated with Bob's avatar 12 such that the context-aware content representation 128 is presented in association with Bob's avatar 12 while within the virtual music store 118.

While the discussion above focuses on virtual environments, the present invention is not limited thereto. More specifically, the context-aware CR engine 40 may be used to provide context-aware content representations in any type of digital environment. For example, the context-aware CR engine 40 may be used to provide context-aware content representations in association with avatars in contact lists or buddy lists, in association with identifiers such as names or photographs in contact lists or buddy lists, in association with identifiers such as names or photographs on webpages such as those on social networking websites like MySpace, or the like.

Those skilled in the art will recognize improvements and modifications to the preferred embodiments of the present invention. All such improvements and modifications are considered within the scope of the concepts disclosed herein and the claims that follow.

What is claimed is:

1. A method comprising:
providing a context-aware content representation based on at least one contextual input; and
effecting presentation of the context-aware content representation in association with a content representation host.

2. The method of claim 1 wherein the context-aware content representation is visually indicative of at least one of a group consisting of: content made accessible by an associated entity represented by the content representation host, content of interest to the associated entity, and content in which the associated entity is disinterested and is influenced by context as defined by the at least one contextual input.

3. The method of claim 1 wherein the at least one contextual input comprises at least one of a group consisting of: a social interaction input, a device information input, a physical location input, a virtual environment location input, and a content access information input.

4. The method of claim 1 further comprising obtaining the at least one contextual input from at least one source.

5. The method of claim 4 wherein the at least one source is a local source.

6. The method of claim 4 wherein the at least one source is a remote source.

7. The method of claim 4 wherein obtaining the at least one contextual input comprises:
receiving the at least one contextual input from the at least one source;
identifying relevant metadata from the at least one contextual input based on a comparison of the at least one contextual input to at least one of a group consisting of: content metadata describing content made accessible by an associated user and user interests of the associated user.

8. The method of claim 7 wherein the relevant metadata comprises relevant keywords from the at least one contextual input.

9. The method of claim 7 further comprising applying at least one input usage rule to the at least one contextual input prior to identifying the relevant metadata.

10. The method of claim 7 wherein the at least one contextual input comprises coordinates defining a physical location of the associated user, and identifying the relevant metadata comprises:
applying at least one input usage rule to convert the coordinates to a text-based location; and
identifying the relevant metadata from the at least one contextual input based on a comparison of the text-based location and the at least one of the group consisting of: the content metadata describing content made accessible by the associated user and the user interests of the associated user.

11. The method of claim 7 wherein providing the context-aware content representation comprises providing the context-aware content representation based on the relevant metadata.

12. The method of claim 11 wherein providing the context-aware content representation based on the relevant metadata comprises:
identifying a plurality of content representations applicable to the content made accessible by the associated user based on the content metadata describing the content made accessible by the associated user; and
filtering the plurality of content representations based on the relevant metadata to provide filtered content representations, wherein the context-aware content representation presented in association with the content representation host is one of the filtered content representations.

13. The method of claim 11 wherein providing the context-aware content representation based on the relevant metadata comprises:
identifying a plurality of content representations applicable to the content made accessible by the associated user based on the content metadata describing the content made accessible by the associated user; and
adding at least one additional content representation to the plurality of content representations based on the relevant metadata, wherein the context-aware content representation presented in association with the content representation host is one of the plurality of content representations including the at least one additional content representation.

14. The method of claim 11 wherein providing the context-aware content representation based on the relevant metadata comprises:
identifying a plurality of applicable content representations; and
modifying one of the plurality of applicable content representations based on the relevant metadata to provide the context-aware content representation.

15. The method of claim 11 wherein providing the context-aware content representation based on the relevant metadata comprises:
identifying a plurality of applicable content representations; and
highlighting one of the plurality of applicable content representations based on the relevant metadata to provide the context-aware content representation.

16. The method of claim 1 wherein the content representation host is an avatar representing an associated user in a virtual environment.

17. The method of claim 1 wherein the content representation host is an avatar representing an associated user in a contacts list.

18. The method of claim 1 wherein the content representation host is an identifier of an associated user in a digital environment.

19. The method of claim 1 wherein the content representation host is an identifier of an associated user in a contacts list of a second user.

20. The method of claim 1 wherein the content representation host is an identifier of an associated user on a webpage.

21. A client device comprising:
a) a communication interface communicatively coupling the client device to a server of a virtual environment; and
b) a control system associated with the communication interface and adapted to:
i) provide a context-aware content representation based on at least one contextual input for an associated user; and
ii) effect presentation of the context-aware content representation in association with an avatar representing the associated user in the virtual environment.

22. The client device of claim 21 wherein the context-aware content representation is visually indicative of at least one of a group consisting of: content made accessible by the associated user, content of interest to the associated user, and content in which the associated user is disinterested and is influenced by context as defined by the at least one contextual input.

23. The client device of claim 21 wherein the control system is further adapted to obtain the at least one contextual input from at least one source.

24. The client device of claim 23 wherein in order to obtain the at least one contextual input, the control system is further adapted to:
receive the at least one contextual input from the at least one source;
identify relevant metadata from the at least one contextual input based on a comparison of the at least one contextual input to at least one of a group consisting of: content metadata describing content made accessible by the associated user and user interests of the associated user.

25. The client device of claim 24 wherein the control system is further adapted to provide the context-aware content representation based on the relevant metadata.

26. A virtual environment server comprising:
a) a communication interface communicatively coupling the virtual environment server to a plurality of client devices; and
b) a control system associated with the communication interface and adapted to:
i) provide a context-aware content representation based on at least one contextual input for a first user associated with a first one of the plurality of client devices; and
ii) effect presentation of the context-aware content representation in association with an avatar representing the first user in a client-specific view of a virtual environment provided to a second one of the plurality of client devices associated with a second user.

27. The virtual environment server of claim 26 wherein the context-aware content representation is visually indicative of at least one of a group consisting of: content made accessible by the first user, content of interest to the first user, and content in which the first user is disinterested and is influenced by context as defined by the at least one contextual input.

28. The virtual environment server of claim 26 wherein the control system is further adapted to obtain the at least one contextual input from at least one source.

29. The virtual environment server of claim 28 wherein in order to obtain the at least one contextual input, the control system is further adapted to:
receive the at least one contextual input from the at least one source;
identify relevant metadata from the at least one contextual input based on a comparison of the at least one contextual input to at least one of a group consisting of: content metadata describing content made accessible by the first user and user interests of the first user.

30. The client device of claim 29 wherein the control system is further adapted to provide the context-aware content representation based on the relevant metadata.
